(19) United States
(12) Patent Application Publication
(10) Pub. No.: US 2020/0005414 A1
(43) Pub. Date: Jan. 2, 2020

(54) SYSTEM AND METHODS FOR PROVIDING A COMMUNITY-BASED CHILD PICK-UP SERVICE

(71) Applicant: Task-KI, Inc., Renton, WA (US)

(72) Inventor: Kanako Matsumoto, Seattle, WA (US)

(21) Appl. No.: 16/453,761

(22) Filed: Jun. 26, 2019

Related U.S. Application Data
(60) Provisional application No. 62/691,509, filed on Jun. 28, 2018.

(51) Int. Cl. G06Q 50/26; G06Q 20/14; G06Q 50/30

(52) U.S. Cl. CPC G06Q 50/26; G06Q 50/30; G06Q 20/145

(57) ABSTRACT

A system, apparatus and methods for providing a community-based child pick-up service, as well as a products and/or services bartering capability are provided. A mobile computing device (such as a smartphone, tablet, or laptop), is configured with an installed mobile application for the community-based child pick-up service. The installed mobile application may include a messaging system/functionality to allow users to communicate among themselves and may also have the capability to calculate service points or rewards. The mobile application communicates with a server or platform over a network, typically a wired and/or wireless network. When a request for the child pick-up service is made by a user, the child pick-up service system (typically implemented as a server or platform communicating with the mobile application over a network) identifies a service provider (such as another parent whose child attends the same childcare facility) who is best suited to perform the requested service for the user. In some embodiments, this may be based on the user's preferences with regards to the person providing the service or some characteristic of the potential service providers.

### CROSS REFERENCE TO RELATED APPLICATION

This application claims the benefit of U.S. Provisional Application No. 62/691,509, entitled “A SYSTEM AND METHOD FOR PROVIDING A COMMUNITY-BASED CHILD PICK-UP SERVICE,” filed Jun. 28, 2018, which is incorporated herein by reference in its entirety (including the Appendix) for all purposes.

### BACKGROUND

Childcare is a paramount need for working parents. Childcare facilities and schools satisfy the need during regular business hours, such as 8 am to 5 pm; however, after-hour childcare services are rare and typically more costly. Furthermore, many childcare facilities have inflexible business hours, such as a strict closing time. This can create a problem for working or busy parents, as when a parent is unable to pick up his or her child prior to the closing time. This can be due to an unexpected event at work or an accident on the road, for example. In such a situation, the parent may face a fine or other penalty and be forced to remove their children from the childcare facility if the late pickup is repeated.

One possible cause of such a delay in picking up a child is that traffic is becoming heavier and is often unpredictable. In many of the large and growing cities in the U.S., the rush hour traffic has become substantially heavier and travel times are often unpredictable. This trend places significant stress on parents who are expected to pick up their children on time, and may cause parents to drive more aggressively, putting themselves and others in danger. In addition, the stress and uncertainty may impact the parents' productivity at work, as the parents must consciously pay attention to the time and possibly also to the traffic in order to reach the childcare facility on time. In this regard, it is not unreasonable to assume that parents who are stressed may negatively impact the well-being of their children, as well.

Furthermore, an extended family model is no longer as common in the U.S. and many parents who are raising children do not have other family members available to support them and pick-up a child when the parent is delayed at work or due to other reasons. Thus, working parents in the U.S. must fulfill multiple responsibilities both at work and home, and often without an established support system that they can rely on in case of emergencies, unexpected work obligations, etc.

The services associated with childcare require reliable and appropriate security measures, and an adequate level of trust between parents and service providers. Finding trustworthy service providers often involves trial and error, and building a trustworthy relationship takes time. Further, there is no easy and flexible way to find a service provider on short notice to perform a childcare service. This means that a parent cannot easily find a replacement for an existing childcare service in the case of emergencies, unexpected work obligations, etc.

Embodiments of the system, apparatus, and methods described herein are intended to address and solve these and other problems or disadvantages of conventional solutions for assisting parents with childcare services, both individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

In accordance with this disclosure, a system, apparatus and methods for providing a community-based child pick-up service, as well as a products and/or services bartering capability are provided. In one embodiment, a computing device, typically a mobile computing device (such as a smartphone, tablet, or laptop), is configured with an installed mobile application for the community-based child pick-up service. The installed mobile application may include a messaging system/functionality to allow users to communicate among themselves and may also have the capability to calculate service points or rewards (e.g., as measured by minutes of services rendered) and keep track of the point balances of users or community members.

In one sense, embodiments of the system register users who have some form of pre-existing relationship with a childcare facility or other service to form a group or type of “community”. This community is comprised of users who are typically customers of a childcare service provider or facility, and who are interested in functioning as either (or both) service providers and beneficiaries of the child pick-up services described herein. The community may be formed based on a specific geographic characteristic, such as being based on a location of (or the general area of users of) a childcare facility. Thus, at least some of the users or community members are expected to be parents or legal guardians of a child who goes to the childcare facility (note that the childcare facility may also include afterschool and/or sports programs).

The system described herein can also be used for other types of care facilities, such as pet daycare and adult daycare, based on a similar implementation. In general, the elements, components, and methods of the system described herein can be applied to groups or forms of communities where people regularly gather and there is a centralized administrator in charge of certain services, and/or who can serve as an intermediary in the request and delivery of certain services.

In one embodiment, when a request for the child pick-up service is made by a user, the child pick-up service system (typically implemented as a server or data processing platform communicating with the mobile application over a wired and/or wireless network) identifies a service provider (such as another parent whose child attends the same childcare facility) who is best suited to perform the requested service for the user. Note that in some embodiments, this may be based on the user's preferences with regards to the person providing the service or some characteristic of the potential service providers (such as location, availability, familiarity with requester or children of requester, etc.). In some embodiments, the system sends a push notification with a distinct alert tone to a pool of potential service providers to alert them to a possible service request. The push notification will typically show the name of the user who is making the pick-up or other service request.

Once there has been mutual acceptance by the user and by a service provider of the service request, the system prompts the service provider to pick up a child of the user at a specific childcare facility. The childcare facility is also notified about the service being performed by the service provider (typically by sending a message to an administrator or other entity at the facility). The system then prompts the childcare facility to authenticate or verify the pick-up of the child of the user by the service provider when the service provider checks in at the facility for the pick-up. The childcare facility checks the service provider in and out of the facility using the system, which notifies the user that their child has been picked by the service provider.

By accepting the request to help the user, the service provider agrees to have their location monitored (via GPS and or wireless network triangulation) through the system until the user receives their child from the service provider. The system shows the progress or stage of the pick-up service requested and provides the location of the service provider to the user during performance of the service.

The user who meets with the service provider to receive the child (typically at the childcare facility, but in some situations at another agreed upon location) sends a completion of service notification to the system and in response, points (typically measured in terms of minutes of service provided) or another token of value for the service are transferred to the service provider (typically as a credit to their account on the system) by the user/parent.

In some embodiments, the system may encourage its users to meet and get to know each in order to increase the amount of mutual trust among themselves. Example trust building activities that may be suggested by the system include, but are not limited to (1) creating an introduction video, (2) communicating with others using the system's messaging system and (3) having in-person meeting(s) prior to using the system's child pick-up function. In some embodiments, after one or more of these on activities, a user can select a pool of potential service providers based on the user's preferences (such as those members of the community in whom the user has a sufficient degree of trust).

Other objects and advantages of the present invention will be apparent to one of ordinary skill in the art upon review of the detailed description of the present invention and the included figures.

### BRIEF DESCRIPTION OF THE DRAWINGS

Aspects and many of the attendant advantages of the claims will become more readily appreciated by reference to the following detailed description, when taken in conjunction with the accompanying drawings, wherein:

FIG. 1 is a conceptual illustration of a community-based child pick-up service system in which an embodiment of the system and methods described herein is implemented;

FIG. 2 is a flowchart illustrating a process, function, operation or method of building a community for a child pick-up service in accordance with an embodiment of the system and methods described herein;

FIG. 3 is a flowchart illustrating a process, function, operation or method of arranging a child pick-up service in accordance with an embodiment of the system and methods described herein;

FIG. 4 is a flowchart illustrating a process, function, operation or method of coordinating with a childcare facility in accordance with an embodiment of the system and methods described herein;

FIG. 5 is a flow chart illustrating a process, function, operation or method of organizing points of users and service providers in accordance with an embodiment of the system and methods described herein;

FIG. 6 is a functional block diagram of an exemplary special-purpose computing device that may be used to implement one or more embodiments of the system and methods described herein; and

FIG. 7(a)-7(cc) are illustrations of a display that may be generated on a mobile device by an installed application as part of implementing an embodiment of the system and methods described herein.

Note that the same numbers are used throughout the disclosure and figures to reference like components and features.

### DETAILED DESCRIPTION

This disclosure is provided with specificity to meet certain statutory requirements. However, this description is not intended to limit the scope of the claims. The claimed subject matter may be embodied in many ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully with reference to the accompanying drawings, which form a part hereof, and which show, by way of illustration, exemplary embodiments of systems and methods implementing the disclosure. The system may, however, be embodied in many different forms and should not be construed as limited to the embodiments set forth herein; rather, these embodiments are provided such that this disclosure will satisfy the statutory requirements and convey the scope of the subject matter to those skilled in the art.

Among other things, the present invention may be embodied in whole or in part as a system, as one or more methods, or as one or more devices. Embodiments of the invention may take the form of a hardware-implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, controller, etc.) that is part of a client device, server, network element, or other form of computing or data processing device/platform. The processing element or elements are programmed with a set of executable instructions (e.g., software instructions), where the instructions may be stored in a suitable data storage element.

In some embodiments, one or more of the operations, functions, processes, or methods described herein may be implemented by a specialized form of hardware, such as a programmable gate array (PGA or FPGA), application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

By way of overview, embodiments of the subject matter disclosed herein are directed to a community-based child pick-up service platform. A computing device, typically a mobile computing device, is configured with an installed mobile application for the community-based child pick-up service. The system registers users in (and supports the formation of) a community and the users of the service may also function as service providers. In some embodiments, a bartering service platform may also be also provided. The installed mobile application includes a messaging functionality or capability to allow users to communicate among themselves and may also include functionality that calculates points or rewards for service providers (typically based on the minutes of services provided), as well as keeping track of the point balances for each user. The system (typically via the execution of software instructions by a programmed processor in a server in conjunction with the installed application in the mobile device) performs one or more of the functions or capabilities described herein.

In one embodiment, the community may be formed based on geographic location, such as being based on the location of a childcare facility. In this situation, the users are typically parents or legal guardians of a child who attends the childcare facility. The childcare facility may also include afterschool programs. Note that an embodiment of the system described herein can be also used for other forms of care facilities, such as pet daycare and adult daycare. In most cases, an embodiment of the system can be used in a group or community where people regularly gather and there is an administrator who can serve as an intermediary in the provision of a service between members of the group.

When a request for child-pick up service is made by a user selecting or activating a control element displayed on their mobile device, the child pick-up service system identifies a service provider who is best suited to perform the requested service for the user. Note that this selection may be based on the user's preference(s); for example, the user may select the desired service provider, place constraints on what type of provider may be used, specify a size of car to be used, specify who else may be in the car while performing the service, etc. Once mutual acceptance of the requested service is established between the service requestor (the user or caretaker of the child involved) and the service provider, the system prompts the service provider to pick up the child of the user at a specific childcare facility, and the childcare facility is notified about the service being performed.

The system then prompts the childcare facility (typically an administrator or other entity at the facility) to authenticate/verify the provider and to notify the system of the pick-up of the child by the service provider when the service provider arrives at the facility. The childcare facility checks the service provider in and out of the facility though the system, which notifies the user that their child has been picked by the service provider. Once the child is picked up, the system sends a notification to the user and provides the meet-up location information to the user and the service provider so that they may meet and return the child to the user.

By agreeing to provide the requested service, the service provider agrees to have their location monitored (e.g., via GPS or wireless network triangulation) by the system until the user receives their child from the service provider. The user who meets with the service provider to receive their child sends a task completion notification to the system, and in response points or tokens for performing the service are transferred to the service provider.

In one sense, embodiments of the system register users who have some form of pre-existing relationship with a childcare facility or other service to form a group or type of “community”. This community is comprised of users who are typically customers of a childcare service provider or facility, and who are interested in functioning as either (or both) service providers and beneficiaries of the child pick-up services described herein. The community may be formed based on a specific geographic characteristic, such as being based on a location of (or the general area of users of) a childcare facility. Thus, at least some of the users or community members are expected to be parents or legal guardians of a child who goes to the childcare facility (note that the childcare facility may also include afterschool and/or sports programs).

The system described herein can also be used for other types of care facilities, such as pet daycare and adult daycare, based on a similar implementation. In general, the elements, components, and methods of the system described herein can be applied to groups or forms of communities where people regularly gather and there is a centralized administrator in charge of certain services, and/or who can serve as an intermediary in the request and delivery of certain services.

In addition, an embodiment may be modified to provide additional services, such as grocery delivery, meal delivery, or a person to exercise with (or participate in another activity). For example, grocery pickups—many people go to the same grocery store as a main source for their day-to-day grocery needs. In this sense, a grocery store can serve as a hub of a “community”. In this example, a person can order groceries on-line and request that a person they trust (most likely a neighbor) who is visiting the store or is nearby to pick up and deliver the groceries in exchange for some form of payment.

Another example embodiment or implementation is that of viewing a Gym or Fitness Center as a hub of a “community”. As with a grocery store, many people go to a specific gym regularly. People are more motivated to exercise if they have a friend to go with to a gym. In this use case, an embodiment may be used to form a carpool. A person can ask to be picked up and taken to a gym with the person who is already planning to go to the gym. The person making the request can also ask for a different person to provide a ride back from the gym if they person want to leave before or after the person who drove them to the gym.

As will be described in further detail, the system and methods described herein may operate most effectively in situations in which there is a pre-existing degree of trust that has been established between the potential group members and the centralized administrator. This assists in establishing some degree of trust among the members of the community that is formed by participating in the child pick-up or other services. In a sense, because the administrator has already performed some type of “vetting”, investigation, or authentication of the potential group members as part of accepting them as customers or clients of the childcare (or other) service, this “trust” between the administrator and the users of the childcare facility forms a baseline to establish a degree of trust between possible users of the child pick-up system and methods. Further, this baseline degree of trust may be encouraged and increased through certain activities, such as events held at the daycare facility, exchanges of information, preparation of an introductory video or message, and other opportunities for potential users of the child pick-up system to get to know and increase trust in each other prior to or during their use of the system and its functionality.

In one embodiment, when a request for the child pick-up service is made by a user, the child pick-up service system (typically implemented as a server or data processing platform communicating with the mobile application over a wired and/or wireless network) identifies a service provider (such as another parent whose child attends the same childcare facility) who is best suited to perform the requested service for the user. Note that in some embodiments, this may be based on the user's preferences with regards to the person providing the service or some characteristic of the potential service providers (such as location, availability, familiarity with requester or children of requester, etc.). In some embodiments, the system sends a push notification with a distinct alert tone to a pool of potential service providers to alert them to a possible service request. The push notification will typically show the name of the user who is making the pick-up or other service request.

In some embodiments, the system calculates an ETA to the childcare facility (i.e., an estimated travel time) based on the current location of the user and the location of the childcare facility. This calculation may be performed prior to the time that the user must leave to travel to the childcare facility in order to arrive at the childcare facility before its closing time (e.g., 10 minutes prior to the required time of leaving work for the childcare facility). The system may send a push notification to the user to inquire whether the user desires to request a service provider to perform the child pick-up. In other embodiments, the system may know the approximate time that the parent typically leaves work to arrive at the childcare facility, and provides a reminder alert to the parent some amount of time prior to when they would normally leave work (in case they will be unable to leave and need someone else to pick-up their child). In some embodiments, traffic conditions and/or weather may be considered when determining the estimated travel time.

Once there has been mutual acceptance by the user and by a service provider of the service request, the system prompts the service provider to pick up a child of the user at a specific childcare facility. The childcare facility is also notified about the service being performed by the service provider (typically by sending a message to an administrator or other entity at the facility). The system then prompts the childcare facility to authenticate or verify the pick-up of the child of the user by the service provider when the service provider checks in at the facility for the pick-up. The childcare facility checks the service provider in and out of the facility using the system, which notifies the user that their child has been picked by the service provider.

By accepting the request to help the user, the service provider agrees to have their location monitored (via GPS and or wireless network triangulation) through the system until the user receives their child from the service provider. The system shows the progress or stage of the pick-up service requested and provides the location of the service provider to the user during performance of the service.

The user who meets with the service provider to receive the child (typically at the childcare facility, but in some situations at another agreed upon location) sends a completion of service notification to the system and in response, points (typically measured in terms of minutes of service provided) or another token of value for the service are transferred to the service provider (typically as a credit to their account on the system) by the user/parent.

In some embodiments, the system and methods described herein enable the creation and/or reinforcement of trust within the community to provide for flexible child pick-up services among users. The system and methods are part of a secure service to allocate available resources (such as parents and legal guardians within the community) to a needed service or function. The described system may also function as a tool to build friendships among parents, legal guardians and caregivers, so that they can develop trust in one another and come to depend on each other.

In most cases, users of the system are limited to those who are members of a particular childcare, afterschool or club community, where participating members are already known and familiar to the facility administrators. Note that as mentioned, the facility administrators already possess some of the users' private information and have likely performed some degree of authentication (and possibly a security investigation) for the users of the facility. This helps to establish a baseline degree of trust between users of the facility and between users and the facility administrator. Note that strangers will not be able to participate in the use of the system, and this enhances the safety of children involved and the trustworthiness of the members of the community. Further, the benefits of creating the trusting community may enable the provision of additional services on a bartering basis between community members, such as babysitting exchanges, pet sitting exchanges, meal preparation sharing, talent/special skill exchanges, or other opportunities to introduce parents to other parents or guardians who might be interested in the childcare facility or afterschool programs.

In some embodiments, the system may encourage its users to meet and get to know each other in order to increase the amount of mutual trust among themselves. Examples of trust building activities that may be suggested by the system include, but are not limited to (1) creating an introduction video, (2) communicating with others using the system's messaging system and (3) having in-person meeting(s) prior to using the system's child pick-up function. In some embodiments, after one or more of these activities, a user can select a pool of potential service providers based on the user's preferences (such as those members of the community in whom the user has a sufficient degree of trust).

For example, in some embodiments, parents or caretakers may engage in activities, communications or events that reinforce or increase a level of trust between them or between certain of them. For example, assume that at an event, Parent A introduces himself or herself to Parents B, C, D and E. Parent A then sends a message to B, C, D and E that mentions that each of them met Parent A in person and asks for a confirmation from them. After this confirmation is obtained, Parent A can then choose which parent(s) he or she wants to put in a set of potential service providers. Suppose Parent A chooses Parent B and Parent D. In this case, B and D will then be part of the set of potential prospective service providers for Parent A, and may be considered preferred providers in some cases.

Embodiments of the system and methods described herein assist in creating and/or reinforcing trust within a community; this enables a flexible child pick-up service to be made available for users and builds a secure and trusted service to allocate available resources within the community. The system can be used as a tool to build friendships among parents, legal guardians and caregivers, so that they can develop greater trust in one another and depend on each other. Note that users of the system are limited to those who are members of a particular childcare, afterschool or club community, and as such participating members are already known and familiar to the facility administrators.

Note further that the facility administrators already possess the users' private information and have performed some degree of authentication (and in some cases a security investigation) for the potential users and service providers. In this way, the trust that has already been established and verified to some extent by the facility is extended to and increased between the members of the community using the facility. Strangers will not be able to participate in the use of the system, and this enhances the safety of the children involved and the trust between members of the community.

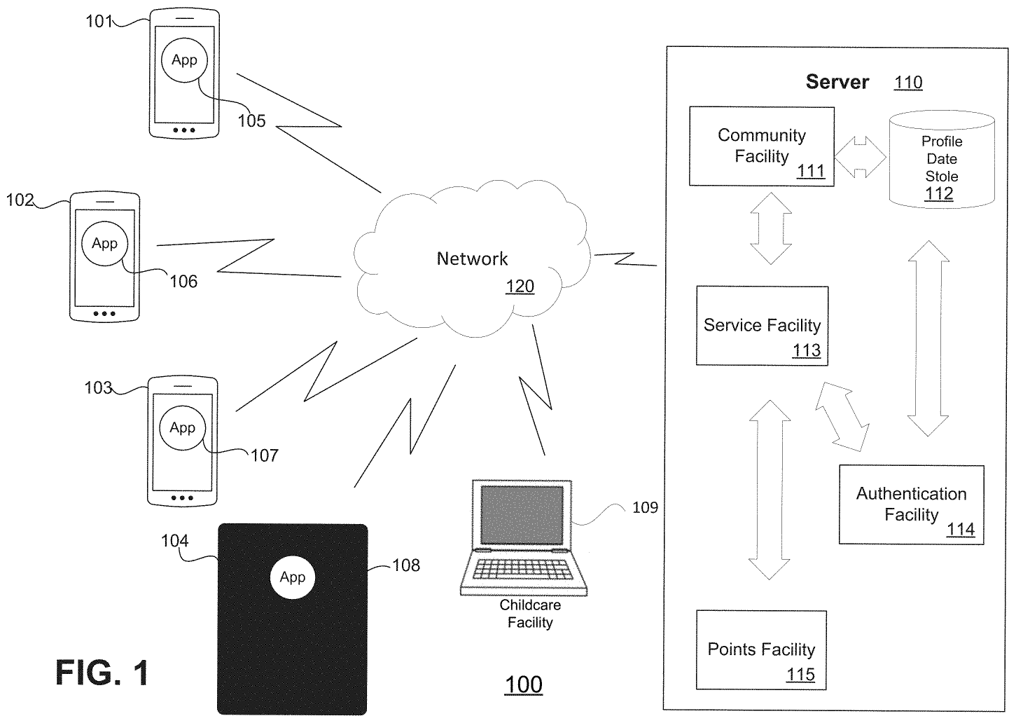

FIG. 1 is a conceptual illustration of a community-based child pick-up service system in which an embodiment of the system and methods described herein is implemented. In this embodiment, the system 100 includes computing devices 101-104, server 110, and a public network 120 (e.g. a “cloud”, such as the Internet). Each of these components will now be described in greater detail.

Network 120 is a publicly available communications network that is accessible from a computing device, either directly or via a local network connection (e.g., Bluetooth, Wi-Fi, etc.). Network 120 enables disparate computing devices to communicate with each other and exchange messages, data and other forms of information. Many different services, such as websites and email, are made available to remote computing devices through Network 120.

Computing devices 101-104 are communicatively connected to Network 120 and may include a laptop, tablet or a mobile phone. The connection between the computing devices 101-104 and Network 120 can be made through a Wi-Fi connection, cellular connection, or other suitable communications connection. Each of the computing devices 101-104 includes a downloaded and installed community-based child pick-up service mobile application 105-108, typically obtained from a website associated with the provider of the services described herein.

Server 110 represents one or more electronic data processing elements or processors that are programmed with a set of computer-executable instructions, typically arranged into routines, sub-routines or modules. When the server executes the instructions, each routine, sub-routine or module may perform a specific function, process, method, or operation. These functions, processes, methods, or operations provide one or more of the features or capabilities of the community-based child pick-up service. As shown in the figure, these features or capabilities may include a community facility 111, profile data store 112, service facility 113, authentication facility 114, and a points facility 115. Each of these components will be described further herein.

The community facility 111 is a component or module which exposes a service or function of building a community for the child pick-up service. The community facility 111 communicates with the computing devices 101-104 via the Network 120 through the mobile apps 105-108. The community facility 111 enables users (i.e., potential users or already enrolled users) to register and to form a “community” among the registered users, based on the users' common use of a specific childcare facility. The users may include parents or legal guardians of a child who goes to the childcare facility. In another embodiment, the users may include childcare facility teachers or facility owners who utilize the services and capabilities of the system described herein.

The profile data store 112 represents data that may be used in conjunction with the community facility 111. The profile data store 112 may store some or all of the profile data of users, including a name, address, childcare information, child information, vehicle information, availability as service providers, desired drop-off location(s), others authorized to pick-up a child, etc. The profile data of users may also include a password for identification when a user is acting as a service provider.

The service facility process, function, or operation 113 is a module or routine that provides the system with the functionality or capability to arrange a child pick-up for users. The service facility 113 also communicates with the computing devices 101-104 via Network 120 through the mobile apps 105-108. Among its functions, the service facility 113 may receive a request for a child pick-up service from a user, identify a possible or desired service provider based on the profile data 112 or real-time availability of one or more potential service providers, and generate and send one or more messages to prompt/request the identified or selected service provider to perform the pick-up request and prompt the user to meet up with the service provider to pick up the child.

The authentication facility 114 is a module or routine that communicates with the service facility 113 and data store 112. The authentication facility 114 operates to perform authentication operations for service providers who come to the childcare facility to pick-up a child of the user. In one example, a user of authentication facility 114 may be a childcare facility employee or administrator (or other entity) who is communicating with the authentication facility 114 via Network 112. In this case, the authentication operations may be performed using a computing device 101-104 via the mobile application 105-108 or by a computing device 109 of the childcare facility via a website of the child pick-up service. In some embodiments, the childcare facility may receive notification of the intended pick-up of the child by the service provider and also receive or be provided access to data regarding the pre-approved consent of the user (i.e., the parent or guardian of the child to be picked up) from the authentication facility 114. The childcare facility may also be prompted to authenticate/verify the identity of the service provider when the service provider shows up to the childcare facility to pick-up the child.

The points facility 115 is a module or routine that enables management of the “points” or credits of users. As used herein, points are tokens used by users of the child-pick up services as a form of payment to a service provider who performed the child pick-up service. In some embodiments, points can be earned by exchanging or bartering services among the users of the system. Once the child pick-up service is completed, the service facility 113 receives a completion notification from the user; this triggers points to be transferred from a user account to the service provider. The points for each user account may be updated in real time. In some embodiments, the system may calculate points to be awarded based on minutes of service provided.

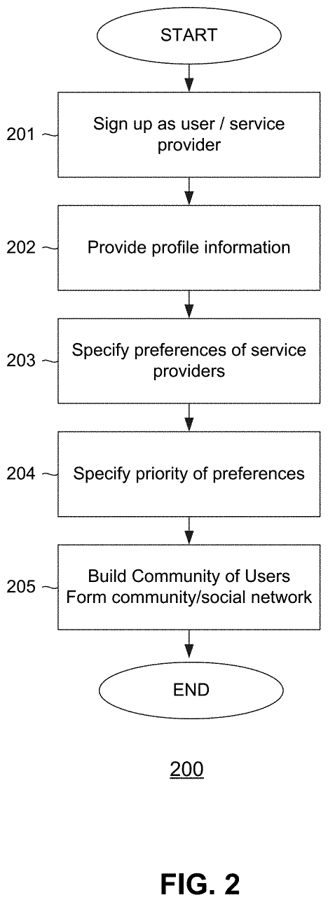

FIG. 2 is a flowchart 200 illustrating a process, function, operation or method of building a community for a child pick-up service in accordance with an embodiment of the system and methods described herein. In one embodiment, to start using the community-based child pick-up services, a person registers as a user and/or service provider (step 201). In one embodiment, users are parents and legal guardians whose child attends a childcare facility or afterschool care. A user can use the mobile application or visit the website of the child pick-up service to register. In one embodiment, the user may need to download a mobile application and pay a subscription fee to participate, such as $5 per month. The user may pay the subscription fee through the website of the child pick-up service or via an on-line store or payment website. In a further embodiment, users may include schools or after school classes, such as sport or arts classes.

Each user registering for the child pick-up service provides profile information (step 202). The profile information may include one or more of a name, address, childcare information, child information, vehicle information, availability as service providers, desired drop-off location, information used to perform a security check, image, etc. The childcare information may include a name of the childcare or school, address, and its regular hours. The child information may include a name, date of birth/age, image, and other information of the child/children of the user, including allergies or special conditions. The vehicle information may include a license plate number, model, year, color, or numbers of seats. The availability of the user as a service provider may be added to the profile information, including dates and time ranges when available or not available, and the information can be updated by the user.

In one embodiment, each user creates a short introduction video as one or both of a user and as a service provider, and uploads the videos to the profile information so that users and service providers can view the video. In another embodiment, the profile information may include a criminal background check, facial recognition, or fingerprint information to provide further data used for a security check and for later identification and verification of authorization.

The user may specify preferences or priorities for service providers in the profile information (step 203). For instance, the user may prefer to have a service provider be located within a certain distance from the childcare facility at the time a request is made, one living in a neighborhood where the user lives or works, to be available at a late evening time, or to be a person they are already acquainted with. In one embodiment, each user may view other user's profiles, including introduction videos and if desired, further communicate with another user via a text or email function that is part of or accessible from the child pick-up service before setting the service provider preferences.

In one embodiment, a user may specify the relative priority among the preferences or characteristics specified in the profile information and if desired, permit the child pick-up service to automatically determine the best-suited service provider when a request comes from the user (step 204). As an example, a user may have two children who attend the same childcare. In this instance, a service provider's vehicle should be able to safely accommodate user's two children in his or her vehicle in addition to his or her own children. Thus, in this example, the user will register his or her preference for service providers who can accommodate such needs and the system will automatically identify the service providers who satisfy the user's requirements. In one embodiment, users will register their relative priority for the preferences (for example, by ordering the preferences or characteristics 1 to 5) and the system will determine the most suitable service provider available at the time a request for service is made.

In some sense, the child pick-up service system may form a social network or community based on users of the same childcare facility or school programs (step 205), where such a community may be limited to parents, legal guardians, and childcare/afterschool program facilities. In this regard, the social network or community functions as a closed group that is involved in providing a safe service based on known and authorized users, service providers, and childcare facilities. Further, as members who can participate in the community are already known to the childcare facilities (who have processed the user's background information), this establishes both another layer of security and a foundation of trust between the facility and potential users, and between potential users themselves.

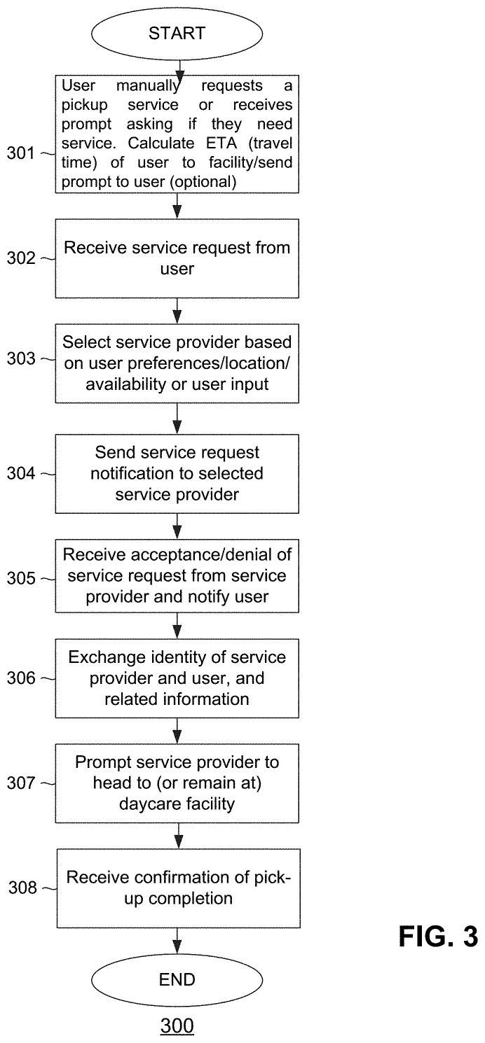

FIG. 3 is a flowchart 300 illustrating a process, function, operation or method of arranging a child pick-up service in accordance with an embodiment of the system and methods described herein. A typical use scenario may start with a user launching a mobile application installed on a mobile device (e.g., tablet, smartphone, laptop, etc.) for the child pick-up service. In one embodiment, the user simply requests a pick-up of their child using the application.

In one embodiment, the ETA or estimated travel time of the user to the childcare facility may be determined or calculated by an algorithm or process which is executed when a specific function or option is selected by the user. The algorithm determines the location of the user and calculates the real time ETA (or estimated travel time) to the childcare facility based on its location (and thus distance) from the user (with or without an added adjustment for traffic, weather, average traffic speed at that time of day, etc.). It then prompts the user to ask if he or she wants to request a pick-up service; this prompt is typically generated in advance (e.g., 10 minutes prior) to the time that the user would need to leave their current location in order to pick up their child based on the calculated estimated travel time.

The ETA (or estimated travel time) calculation may be performed dynamically while the mobile application is turned on, or manually performed when the user initiates the function. In one embodiment, the calculation of the ETA (or travel time) may be performed based on several factors, including the location of a user, traffic conditions, weather conditions, and the addition of an amount of buffer/extra time, which may be set by default (such as 5-10 minutes) or by the user's preference; this allows for variations in traffic, unexpected events along the route, etc. In one embodiment, the user's current location may be determined by a GPS function built into a mobile device and the traffic conditions may be determined from the map/navigation functionality built into the mobile device.

Based on the calculated ETA (or travel time), the system may send a notification to the user regarding the time when the user needs to leave the current location to pick-up their child at the childcare facility and ask if the user wants to request a pick-up service. The notification may be made by push notification of the mobile application or by text or email functionality built into the mobile application. In one embodiment, if a calculated ETA (based on the user's work location or location while travelling to the facility in the event they have left work) would result in the user arriving at the facility past the regular pick-up time or after the latest possible pick-up time at the facility, then the user may be alerted by a prompt of the mobile application that the user needs to arrange for the pick-up service.

Note that the user may skip this step and directly send a request for the child pick-up service, with the request being received by the system (step 302). The request may be initiated by a voice command or touching a button or selectable element so that the user can initiate the request almost hands free while driving.

Once the request for pick-up assistance is received, the system selects a service provider (or set of potential service providers) in the community which the user belongs to, based on one or more of the preferences specified by the user, availability of the service provider(s), and the location of the service provider(s) (step 303). In one embodiment, service providers are automatically selected based on their location being within a certain distance of the facility and hence their ability to pick up the user's child on time. Thus, potential service providers who do not meet this requirement would not be selected in response to the user's service request and do not see the prompt/request for assistance.

If the system fails to identify a service provider based on the user preferences, then the system may select a service provider based on proximity to the childcare facility or afterschool program location. If the system does not find a potential service provider based on proximity, then the system may select the service provider based simply on availability of the service providers in the community. If no service provider is identified, then the service request made by the user is denied. If the service request is denied, then the user may be presented with an option to increase the reward or payment points for the requested service in order to provide a greater incentive on the part of potential service providers to accept the request. The set of possible service provider selection steps or stages are typically performed by an algorithm of the child pick-up service and used to select the best service provider for the request.

In one embodiment, the highest priority condition for a service provider to be able to provide the pick-up service may be his or her location at the time the request is made. In this embodiment, if a service provider is not within the required distance/range to guarantee being able to provide the pick-up service on time, then the service provider is omitted from the group of candidate service providers to perform the service.

If the location requirement is satisfied, then, the priority may be determined based on the user's pre-determined preference(s) with regards to person, size of car, additional passengers, provider's home location, etc. In some embodiments, once a set of potential service providers are identified based on availability and location, the system may then filter the set based on user preferences, prior user approval of using the service provider, selection of one service provider by the user after receiving a list of potential providers, etc.

Once a service provider for a request is selected, the system sends the service provider notification of the request (step 304). The notification may include information about the pick-up request, such as the name of the user, the name of a child for pick-up, the time of pick-up, and the drop-off location. The notification may be provided by a push notification functionality of the mobile application or by text or email notification that is part of the functionality of the mobile application.

If the service provider is selected based on the schedule (i.e., the availability schedule that shows who is available to help other parents) specified in the profile information, then the service provider will receive a pickup request. The service provider can manually accept or deny (refuse) the service request. Once the system receives acceptance or denial of the service request from the service provider, the user is notified (step 305). Notification may be provided by push notification functionality to the mobile application (in coordination with a distinctive alert tone) or text or email notification built into the mobile application. The service provider selected for the service is removed from the eligible service provider candidates in the community until the service provider completes performing the requested task.

The acceptance by the service provider of the request triggers a release of the identity of the service provider to the user, including their name and the vehicle information for the service provider (step 306). Note that the information about the user and child, including one or more of a name of the user, a name of the child, age of the child, the child's allergy information (if applicable), the pickup location (e.g., the child's daycare facility), a drop-off location to meet the service provider and the user's car information will have been provided to prospective service providers when a service request is made by the user.

The service provider is then prompted to head to (or remain at) the childcare facility or afterschool program location at the specified time to perform the pick-up service (step 307). Once the child that is the subject of the request is picked up by the service provider, the user receives confirmation of the pick-up from the childcare facility (step 308). The completion of the pick-up prompts both the user and service provider to head to the drop-off location specified by the user. In one embodiment, the system may send a message with an ETA for the child to arrive at the drop-off location.

Note that in some embodiments, the notification(s) sent from the child pick-up service are delivered through a function of the child pick-up service system and provided as a notification on the mobile application or through a text or email.

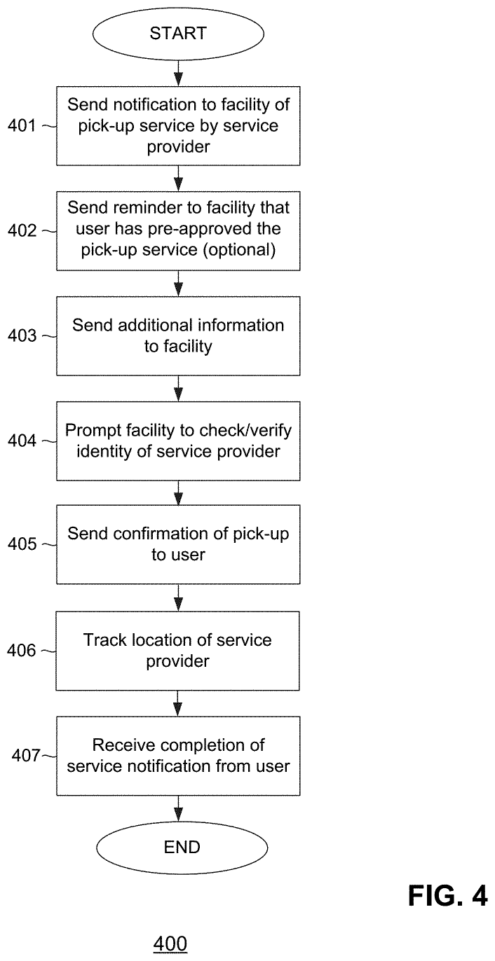

FIG. 4 is a flowchart 400 illustrating a process, function, operation or method of coordinating with a childcare facility in accordance with an embodiment of the system and methods described herein. When the service request from the user is accepted by the service provider, the childcare facility receives notification of a scheduled pick-up service by the service provider for a child of the user (step 401). The notification may be made through the mobile application function or through a text or email built into the mobile application. Notification may also be provided by an email generated by the system platform and sent to an email account of the facility.

In some embodiments, the system may send a reminder to the facility that the user has provided a pre-approved authorization for the service (step 402). In one embodiment, the childcare facility may receive additional information regarding the pick-up request, such as a car seat request or other information regarding the specific pick-up (step 403). For instance, if the request is for picking up two children but the service provider has only one car seat, then the childcare facility may be asked to rent an additional car seat for the service provider to use, where the car seat can be returned by the user to the facility the next day.

Note that the verification of the service provider prior to release of a child may be customized in accordance with the policy of each childcare facility. In one embodiment, valid identification may be required to be presented by the service provider to the childcare facility in order to validate the service provider's identification before the user's child is released to the service provider (step 404). In one embodiment, the verification/authentication may be performed by matching fingerprints, biometrics, secret codes, or passwords that are specified by a user. Once the child is picked up by the service provider, the system sends confirmation of pick-up as a mobile application notification or voice command to the user (step 405).

The confirmation of the pick-up of the user's child by the service provider at the childcare facility triggers a process to track the real-time location of the service provider. This may be accomplished using the built-in GPS functionality of the mobile computing device of the service provider (step 406). This tracking function is maintained until the user sends a completion of service notification to the system (step 407).

As expected, it is important to ensure that the location of the service provider with the user's child is known and monitored for safety and to ease the user's concerns. Although the system operates on the premise that a user has selected his or her service provider(s) based on who they trust with the user's child, a parent will welcome a mechanism (such as the tracking function) that lessens their concerns about their children. In one embodiment, if it is preferred by the user and agreed to by the service provider, a wearable tracking device can be placed by the childcare facility on the service provider (note that this may be a disposal device) that can be unlocked only by the user when the user receives his or her child from the service provider. This service can be provided for an additional fee.

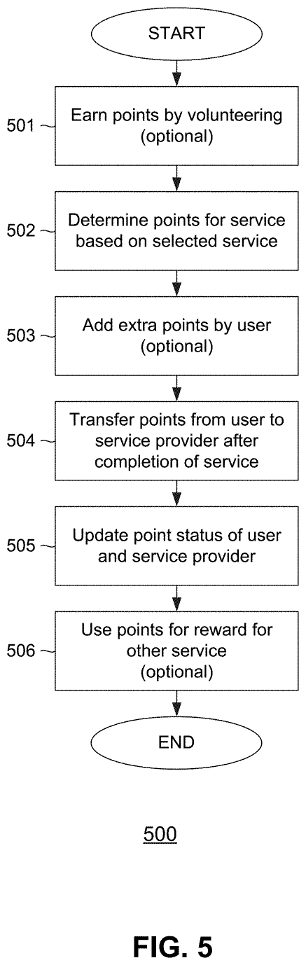

FIG. 5 is a flow chart 500 illustrating a process, function, operation or method of organizing points of users and service providers in accordance with an embodiment of the system and methods described herein. The points represent a reward for a service provider and also payment for the service request. A user of the community-based child pick-up service described herein typically earns points by volunteering as a service provider (step 501). In one embodiment, when a user registers for the child pick-up service through the mobile application, the user may receive a certain number of points to enable them to start using the service before volunteering as a service provider. In some embodiments, points (or other form of reward or payment token) cannot be purchased using money, and are only earned by performing child pick-up services or other services, or by performing a special task described by the system.

When a service request is made by a user, the point system typically determines how many points are offered for performance of the requested service based on the terms or conditions of the request (step 502) for the pick-up service. In one embodiment, the number of points available to a service provider is based on the amount of time spent providing the service (e.g., one point for each minute). In one embodiment, the points awarded for completion of the task may be determined based on conditions of the request, including the time the request is made, the availability of the service providers, the urgency of the request, the number of children for pick-up, the time it takes for the user to pick up their own child from the service provider, or the distance to the drop-off location (in short, the perceived value to the user of having the request fulfilled by a service provider).

In one embodiment, the points can be calculated by an algorithm or decision process based on a weight or priority assigned to each of several factors or characteristics, and may be determined for example, by the system or by the user at the initial set up of the service preferences. In one embodiment, the parties to the service (the user who has a child needing pick-up and the prospective service provider) may determine the number of points awarded to the service provider based on a negotiation.

As noted, in one embodiment, the system may determine a number of points to be awarded based on preferences set by the system or users. In one embodiment, one point may be equivalent to one minute of the time spent by a provider in fulfilling a request for service. The service duration for measuring points may be calculated starting when the service provider receives the user's child from the childcare facility and ending at the time that the user receives his or her child from the service provider at the previously agreed-upon location. For example, if this duration is 20 minutes, then 20 points are granted to the service provider when the user picks up his or her child form the service provider.

Note that in one embodiment, the points awarded to a service provider may be increased or set by a user (step 503). For example, if there is no service provider available (or willing to accept the request) when the user makes a pick-up request, a user may decide to increase the points to be granted in order to provide an added incentive for a service provider to accept the request. In this case, the user will input an amount of additional points to be awarded and the system will recalculate the total points to be transferred or exchanged upon the completion of the service.

Note that typically, points are not sellable or purchasable using money; however, they are transferable to other users. As mentioned, a user may add extra points to a service request in order to find a service provider quickly or more efficiently (step 503). Further, points can be transferred to others as a goodwill gesture to those who need them (such as for an unexpected need for a pick-up, etc.).

Once the service request task is performed by the service provider and the system receives a completion notification for the service from the user, the points specified for the service request are transferred by the system from the user account to the service provider account (step 504). The point status for users (in this case the user and service provider) is then updated (typically in real time) and viewable by the users (step 505).

In one embodiment, if a user wishes to use their points balance (in whole or in part) as a reward/payment for a service, then the user may be able to offer a certain amount of points as part of making a service request (step 506). In one example embodiment, the points may be used in exchange for a babysitting service or for redeeming a merchandise item. In another embodiment, the system may include a talent board where parents can describe their talents or special skills, which can be provided in exchange for a user's points. For example, if a parent is a school teacher, his or her talent may be tutoring certain subjects to children. In this situation, a user may use points earned as a service provider to ask another user to provide a service, such as tutoring his or her child.

Another example is that of a parent who is skilled at baking. He or she may register this talent in the system, and a user may exchange a certain number of points by asking this parent to make a pie. In a further embodiment, the system may incorporate a dinner exchange program where users can offer to make a dinner for other users. Note that this program and its service offerings can be offered independently from the pick-up service or may be combined with the pick-up service. For example, a weekly calendar of available dinner preparation or delivery times can be shown by one user and items or services can be purchased by other users using the points they have earned. In this situation, a user can send a request for a dinner item and offer (or agree to pay) a certain amount of points, and the dinner item is then brought to the childcare facility for pick-up. At the time of the dinner pick-up, the system may transfer the predetermined points to the user who delivered the dinner item. In some cases, the points given by the user to the service provider may be negotiated between the parties, or determined by a set of rules.

Below is a Table that provides a summary description of certain functions, processes, methods or operations that may be implemented in an embodiment of the system and methods described herein:

| Short Description | Feature | App functionality |
|---|---|---|
| Native Multi-Platform | Native Android and iOS | The app may run natively on both Android and |
| Support | Support | iOS devices for a user. |
| | | (apps will typically be developed natively in |
| | | Swift (iOS) and Java (Android)) |
| Intro | Splash Screen | Provide a splash screen introducing a user to |
| | | the app. |
| Intro | Sign Up/Sign In | Provide user with ability to sign up for an |
| | | account or sign into an existing one. |
| Intro | App Introduction Video | Create and display a pre-recorded video |
| | | introducing the app to a user. |
| Registration | Main Profile | Create a profile of a user with required |
| | | information to use the app. |
| Registration | Sign-In Settings | Receive sign-in info of a user, including email |
| | | address, password. |
| Registration | Childcare Facility | Select user's childcare facility. |
| | Information | |
| Registration | Child Information | Receive information for children of a user at |
| | | the daycare, including, a car seat type used by |
| | | the child. |
| Registration | Vehicle Seat Availability | Specify capacity of seats in a vehicle of a user. |
| Registration | Car Seat Availability | Specify number of car seats available in a |
| | | vehicle of a user. Need to apply logic to |
| | | determine if person is eligible to be a service |
| | | provider based on 1) number of seats and 2) |
| | | car seats available. |
| Registration | Availability Schedule | Display schedule specifying availability of a |
| | | user as a service provider for a week. Need to |
| | | apply logic to determine if person is available |
| | | for the timeframe when a pick-up service is |
| | | requested. |
| Registration | Talent Board | Specify talents showcased by users for |
| | | bartering services (cooking, yardwork, pet |
| | | sitting, etc.). |
| Registration | Self-introduction Video | Create a 30 second video of user introducing |
| | | self to other members in the community. |
| Registration | Legal Terms | Show terms and conditions related to the app |
| | | and receive acceptance from a user. |
| Group Messaging | Group Messaging | Enables a user to send private messages to |
| | | other users by way of group messaging. |
| Private Messaging | Private Messaging | Enables a user to send a private message to |
| | | another user. |
| Map View | Parent User - Request | Provide a map view with a UI module that |
| | View | allows a parent user to request pickup service |
| | | for their child and specify an address for |
| | | pickup. Provide an option for a parent user to |
| | | specify an address to meet the service |
| | | provider. If it is different from the childcare |
| | | facility, then the user inputs the address. |
| Map View | Confirmation of Pickup | The user confirms the details of pickup, |
| | Details by User | including the name of child, age and the |
| | | address to meet up with the service provider. |
| Push Notifications | A Push Notification to | A Push Notification with a distinct alert tone is |
| | available service | sent to a pool of the service providers who are |
| | providers | available for the request. |
| Push Notifications | Service Provider | A confirmation of acceptance is sent to the |
| | accepts user's pickup | user. |
| | request | |
| Push Notifications | Parent User - No | Provide updated UI if no service provider is |
| | Servicers Available | available, either due to unavailability during the |
| | | time frame or the service provider declines the |
| | | request. |
| Map View | Parent User - Status | Provide status view with the current status of |
| | View | the pickup request. Need to integrate with |
| | | Google Maps API. |
| Map View | Parent Servicer - | Provide instructions for the pick request, such |
| | Instruction View | as map view to a pickup location. Need to open |
| | | default maps application to show navigation |
| | | instructions. |
| Admin View | Childcare Administrator - | Provide a pending request for pick up. |
| | pickup request pending | |
| Administrator View | Childcare Administrator - | Provide a screen of check in and out at facility. |
| | check in and out | |
| Map View | Parent Servicer - At | Provide a map view to a service provider with |
| | Daycare | destination if different from the childcare |
| | | facility. |
| Map View | Parent User - Status | Provide a status view that the service provider |
| | View Updates | has arrived at the childcare facility and that |
| | | pick up is complete, and map view for user with |
| | | the current location of the service provider. |
| | | May provide an option to the user to open an |
| | | external navigation app with the current and |
| | | destination location displayed. |
| Map View | Parent Servicer - Arrival | Provide a screen to confirm arrival at the |
| | Confirmation | destination. |
| Map View | Parent User - Status | Provide a status view to notify that the service |
| | View - Arrival | provider has arrived at the destination and |
| | | waiting for the user's arrival. |
| Map View | Parent User - Status | Provide a status view to confirm the pickup |
| | View - Pickup | completion. |
| | Completion | |
| Map View | Parent Servicer - | Provide a screen to a service provider when |
| | Exchange Complete | the service has been completed. |
| Dynamic ETA | Dynamic ETA | Notify a parent user by push notification when |
| | | ETA (based on traffic condition and current |
| | | location) of the parent user plus some time |
| | | buffer is reached, so that the parent user |
| | | knows that the parent user will be late and will |
| | | require a service provider's service. |
| Point Management | Parent User - Points | Transfer points of a parent user after the |
| | | completion of the pickup service. |
| Point Management | Parent Servicer - Points | Update points of a service provider who is |
| | | providing the pickup service. |
| Point Management | Manual Transfer | A user may manually transfer points to another |
| | | user for ad-hoc services. |
| Settings | Profile Management - | A user may edit own profile with general |
| | General Info | information, and have it saved to the user's |
| | | account. |
| Daycare Admin Panel | Create Profile - Daycare | Create a profile of a daycare administrator with |
| | Admin | required information to use the app. |
| Daycare Admin Panel | Daycare Admin UI | Allow a daycare administrator to access an |
| | | admin-specific section to view information |
| | | related to any existing service requests. |

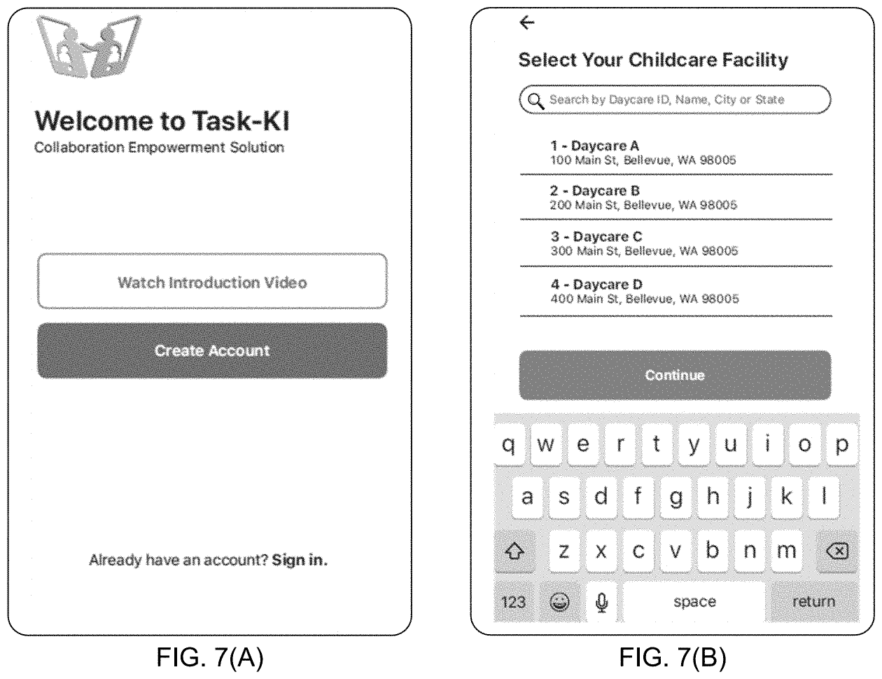

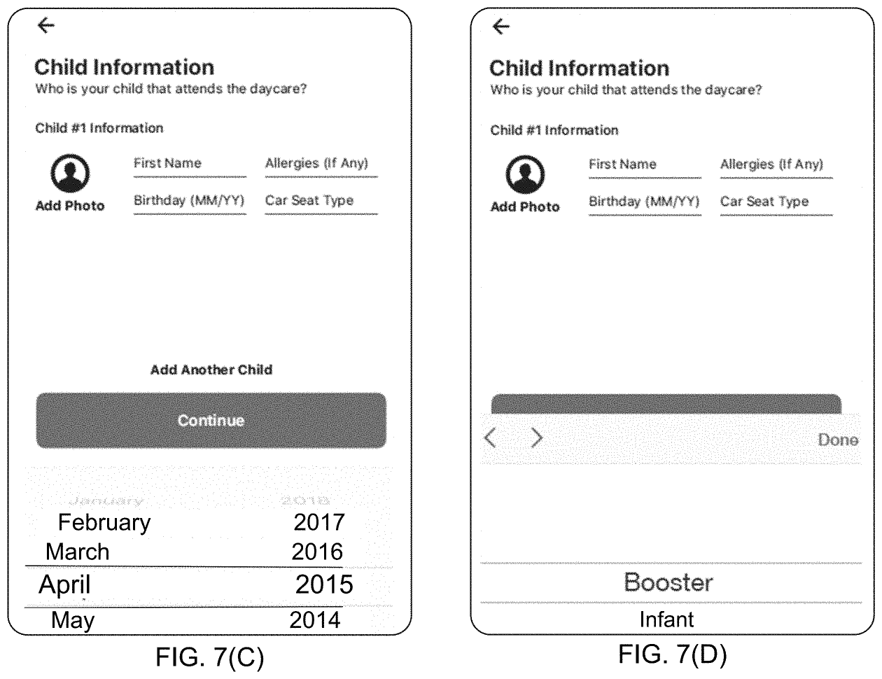

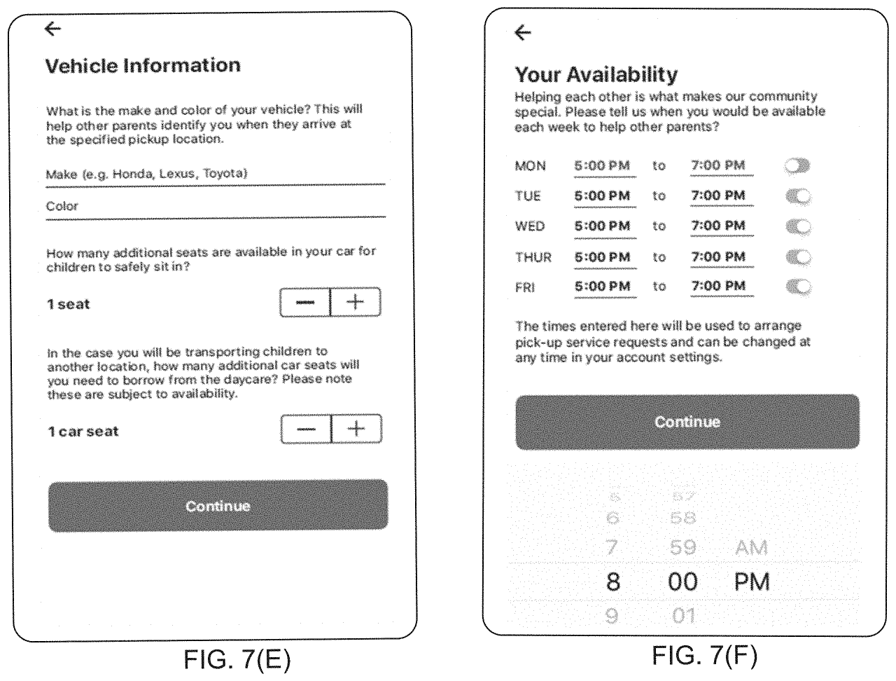

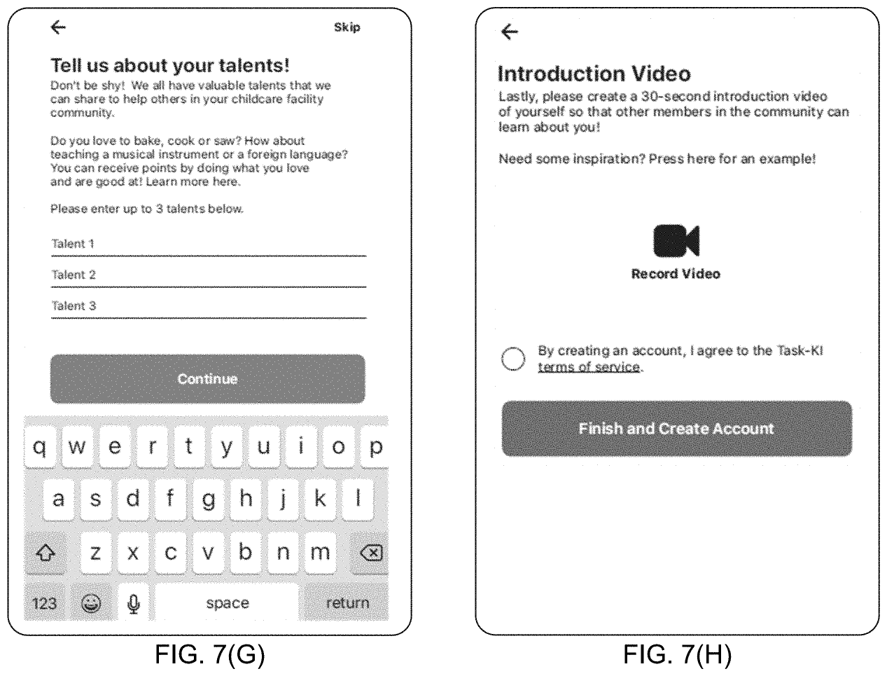

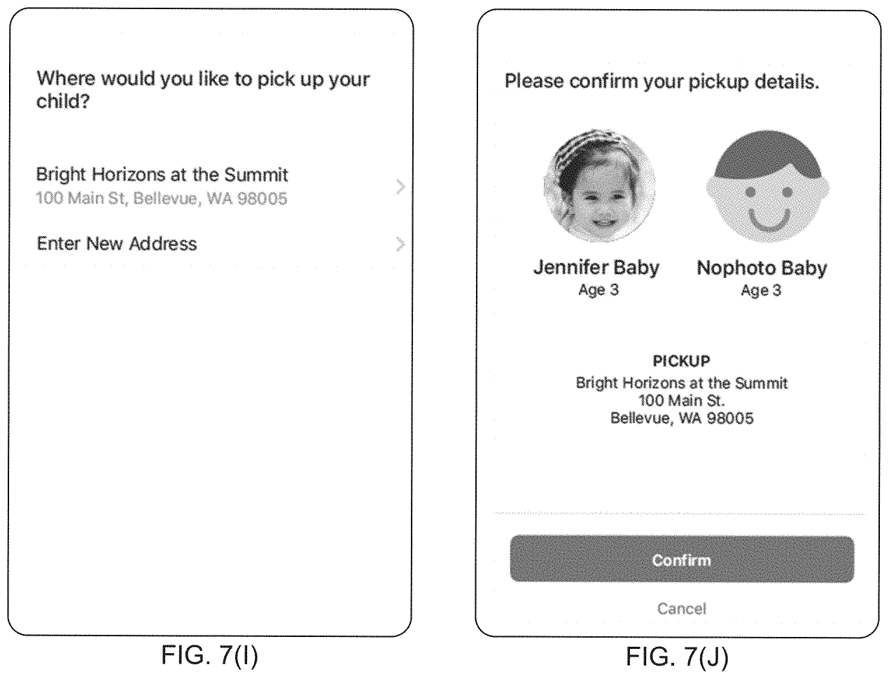

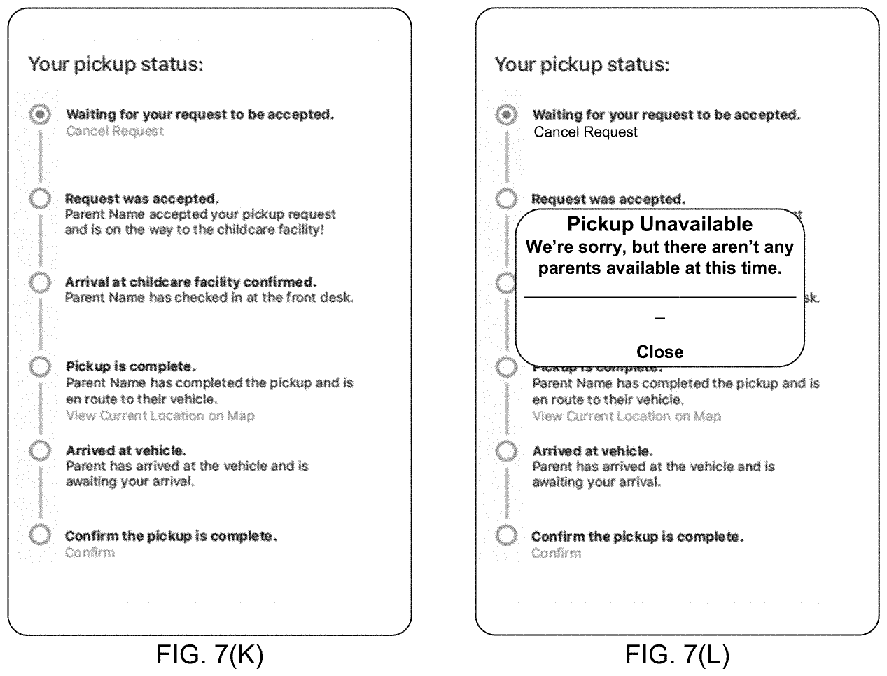

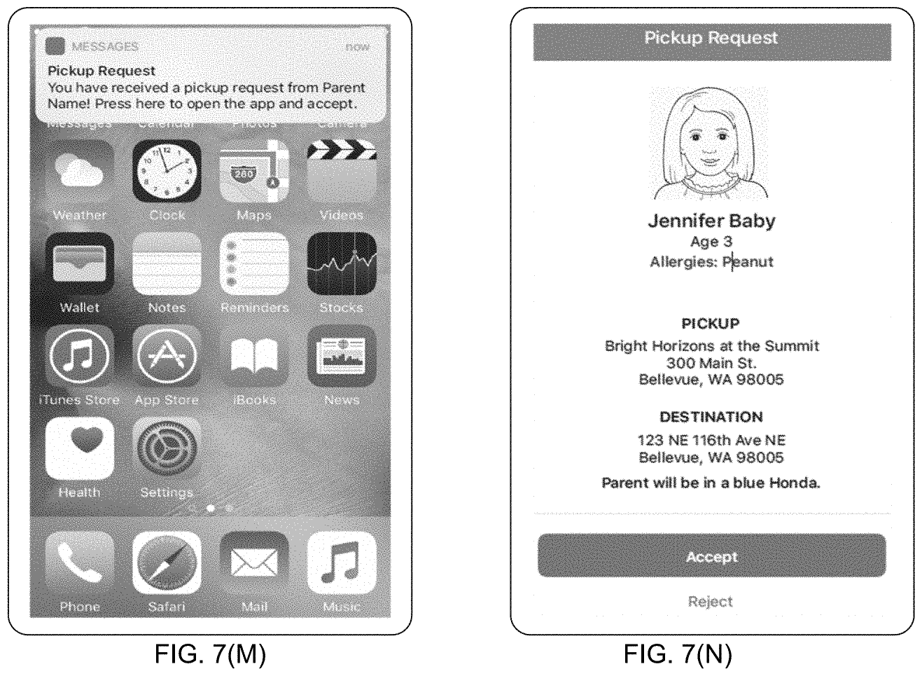

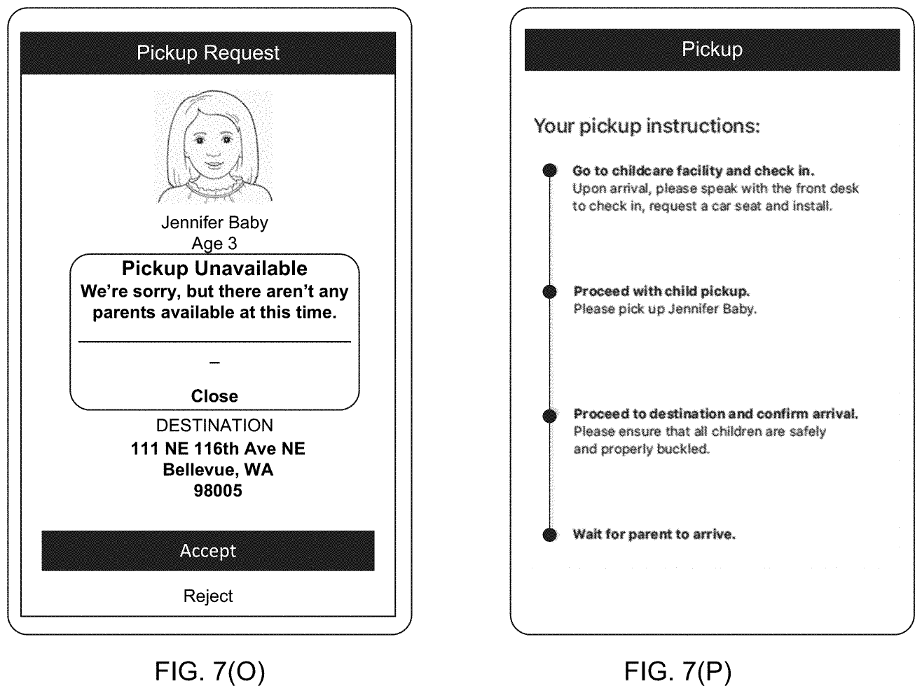

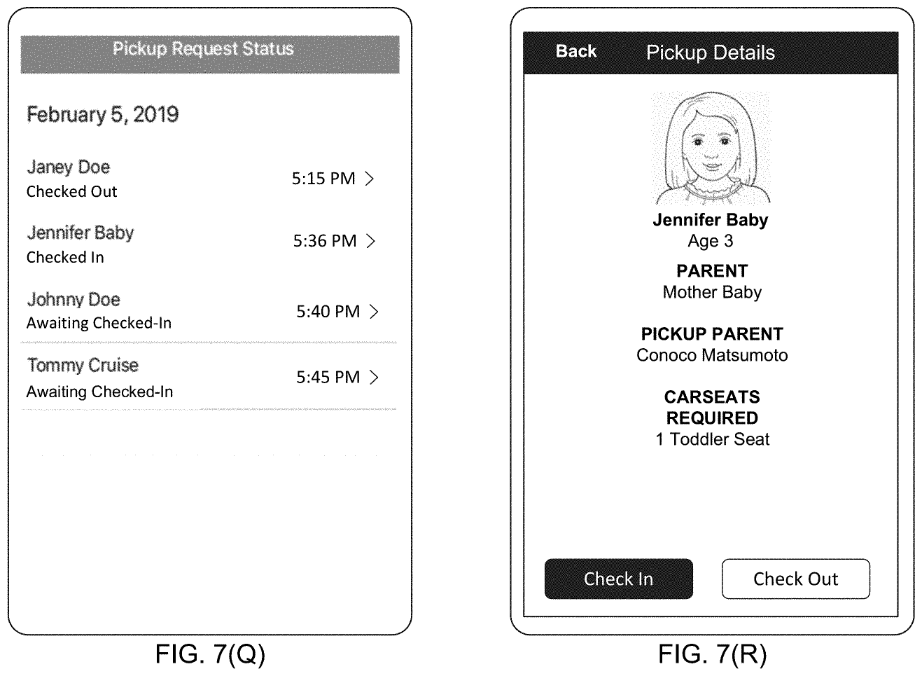

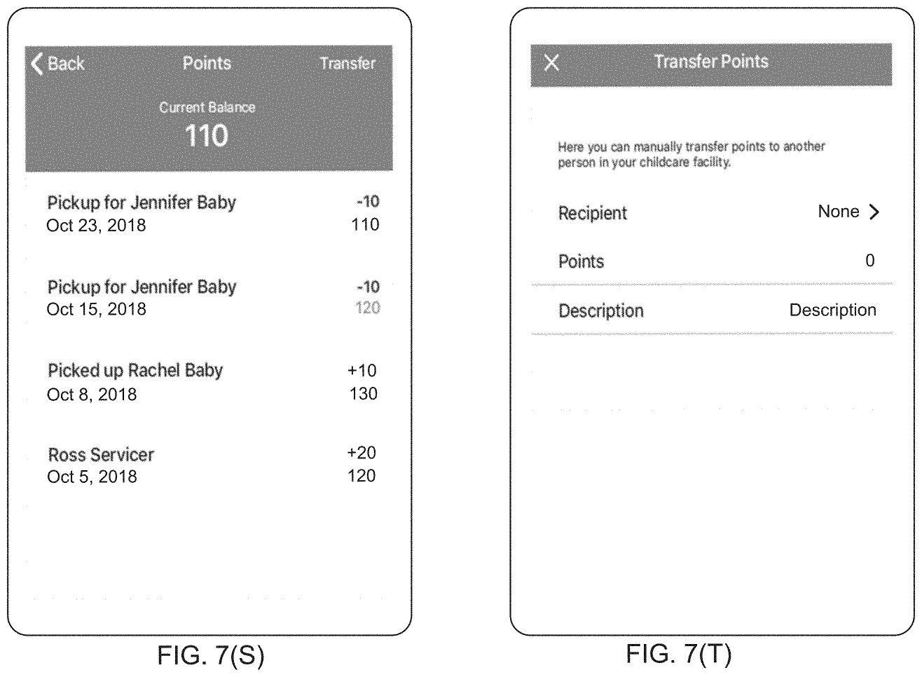

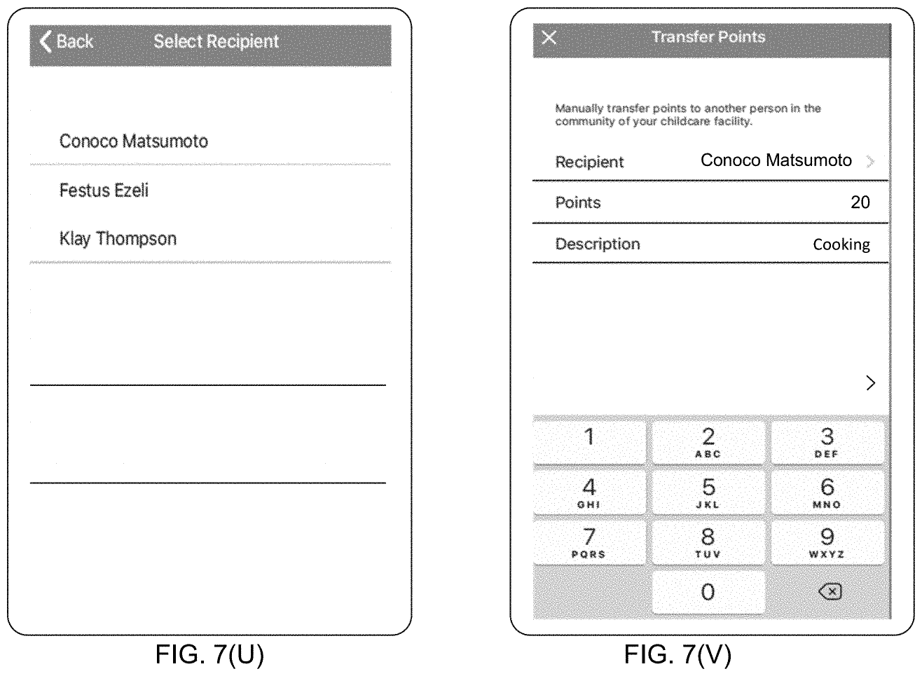

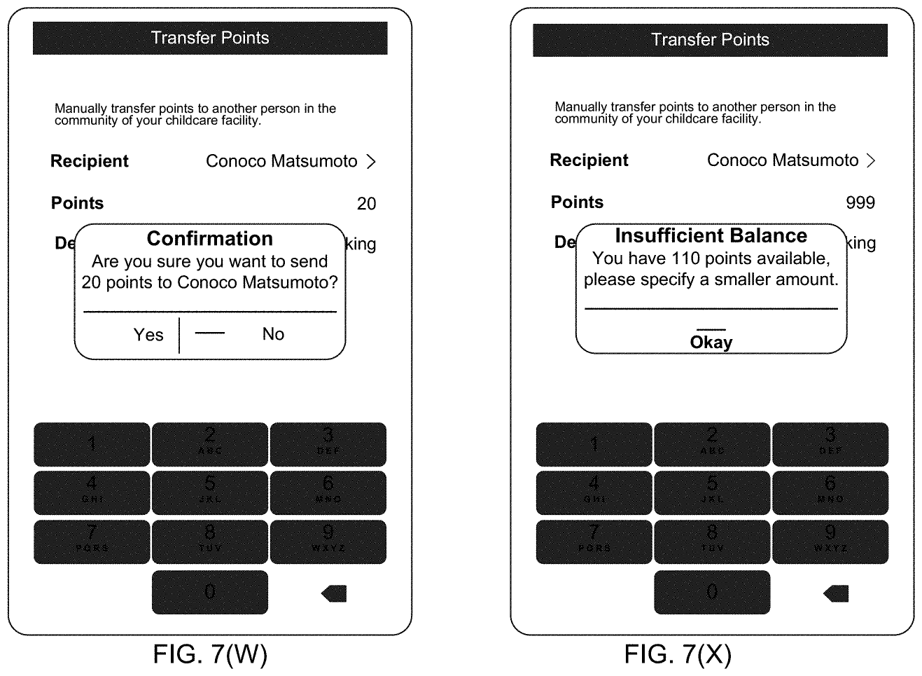

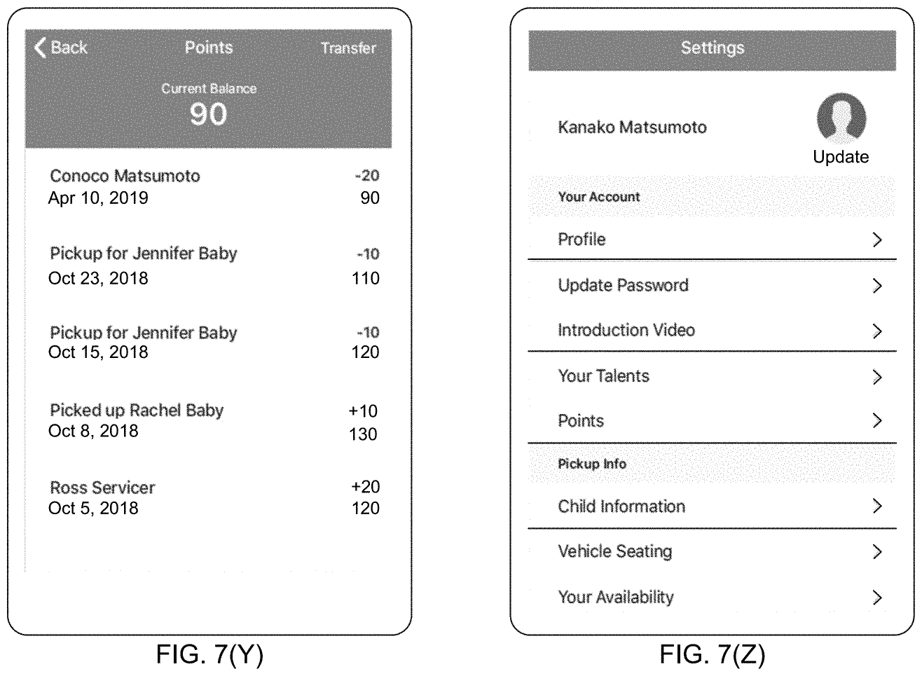

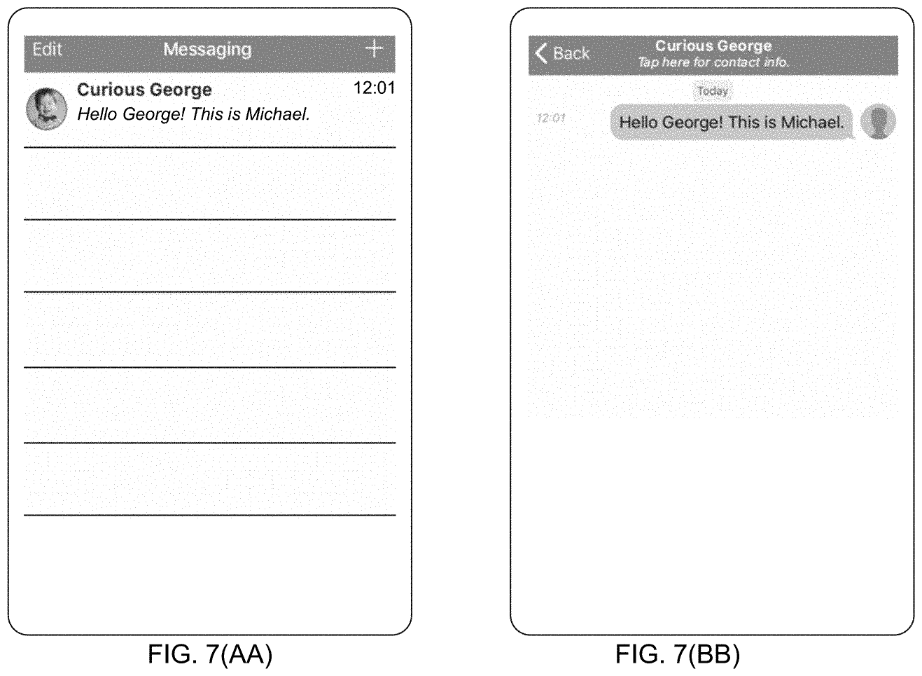

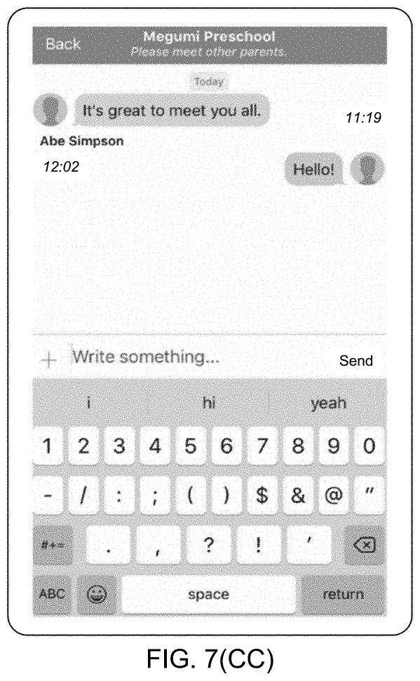

FIG. 7(a)-7(cc) are illustrations of a display that may be generated on a mobile device by an installed application as part of implementing an embodiment of the system and methods described herein. Note that the Figures or displays/screenshots represent examples of the user interfaces that may be generated by an application installed in a mobile device and/or a server in communication with the installed application as part of enabling a user to register for the child pick-up service, request a pick-up for their child, agree to perform a pick-up service and transfer points or tokens to a recipient who performed a service. Some of the displays may include selectable options or “buttons” that may be used to initiate a function, message, or other feature of the system. As shown in the figures:
FIG. 7 (a) illustrates a screen display of a frame or “page” displayed when the app is opened for the first time. As suggested by the figure, a user can select/click to watch a video for a brief summary of how to register for the service. For an admin user (such as an employee of a childcare facility), he or she will select the car logo (note that this is just an example of a possible logo and may be replaced by one representing the service) to create an account;

Registration Information Entry
FIG. 7(b) illustrates a screen display of a frame or “page” which enables a user to choose which childcare facility their child attends;
FIG. 7(c) illustrates a screen display of a frame or “page” which enables a user to enter a user's child (children) information (e.g., first name, Birth Date, allergy information and car seat type); the bottom section of the figure is illustrating how to set the birthdate;
FIG. 7(d) illustrates a screen display of a frame or “page” which enables a user to enter an identifier of a car seat for a child of the user;
FIG. 7(e) illustrates a screen display of a frame or “page” which enables a user to enter a user's vehicle information (e.g., make and color of the user's vehicle, seating space availability and car seat needs of the user);
FIG. 7(f) illustrates a screen display of a frame or “page” which enables a user to enter a user's availability to help other parents with child pick-up services; parents in the community who are available for desired pick-up times or time intervals will receive a push notification for a pick-up request;
FIG. 7(g) illustrates a screen display of a frame or “page” which enables a user to enter a user's talents or skills, so that other parents can see what products and services can be exchanged within the group;
FIG. 7(h) illustrates a screen display of a frame or “page” which enables a user to record an introductory video, so that other parents can get to know the user; a user can also click to watch an example of an introductory video;

Request Pick-Up
FIG. 7(i) illustrates a screen display of a frame or “page” which enables a user to generate a request for a pick-up service and confirm or enter a place or location where to meet a parent who provides the service;
FIG. 7(j) illustrates a screen display of a frame or “page” which enables a user to confirm the user's pick-up request details, including the name of child to be picked up and place of the pickup (i.e., the childcare facility);
FIG. 7(k) illustrates a screen display of a frame or “page” which shows that a pickup request is in pending;
FIG. 7(l) illustrates a screen display of a frame or “page” which indicates that no pickup is available (if no parent is previously registered for the time frame to help);
FIG. 7(m) illustrates a screen display of a frame or “page” which shows a push notification that may be received for a pickup request (in some embodiments, this may be associated with a distinctive notification sound);

Fulfill Pick-Up Request
FIG. 7(n) illustrates a screen display of a frame or “page” which a parent service provider may use to confirm that he or she has agreed to pick-up a child;
FIG. 7(o) illustrates a screen display of a frame or “page” which indicates that a pick-up request has been already fulfilled by another parent;
FIG. 7(p) illustrates a screen display of a frame or “page” which shows the instructions/rules/procedures that a parent picking up someone else's child is expected to follow once he or he accepts a pickup request;
FIG. 7(q) illustrates a screen display of a frame or “page” which shows the Admin (childcare facility) pickup request status screen, which includes information regarding the status of all pending or confirmed pickup requests;
FIG. 7(r) illustrates a screen display of a frame or “page” which shows the Admin's check in and check out screen for a service provider and a child being picked up; in one embodiment, the screen shows a name of a child to be picked up, a name of a requesting parent, a name of a parent who is picking up, and any car seat needs;

Points Transfer as Payment for Service
FIG. 7(s) illustrates a screen display of a frame or “page” which shows the point balance history and the current balance that is available to be used by a user;
FIG. 7(t) illustrates a screen display of a frame or “page” which shows a screen where a user can transfer points to another parent; or group member;
FIG. 7(u) illustrates a screen display of a frame or “page” which shows a list of other parents to whom a user can choose to transfer points;
FIG. 7(v) illustrates a screen display of a frame or “page” which enables a user to enter a number or amount of points to be transferred to another member of the group;
FIG. 7(w) illustrates a screen display of a frame or “page” which enables a user to confirm the transfer of the points;
FIG. 7(x) illustrates a screen display of a frame or “page” which informs a user that the user does not have enough points to transfer the amount they specified;
FIG. 7(y) illustrates a screen display of a frame or “page” which displays/confirms an amount of points transferred from the user to another member of the group;

General Functions
FIG. 7(z) illustrates a screen display of a frame or “page” which shows the settings screen where changes/edits can be made;
FIG. 7(aa) illustrates a screen display of a frame or “page” which enables a user to participate in an individual messaging communication;
FIG. 7(bb) illustrates a screen display of a frame or “page” which shows a conversation between individuals; and
FIG. 7(cc) illustrates a screen display of a frame or “page” which shows conversations in a group messaging communication setting.

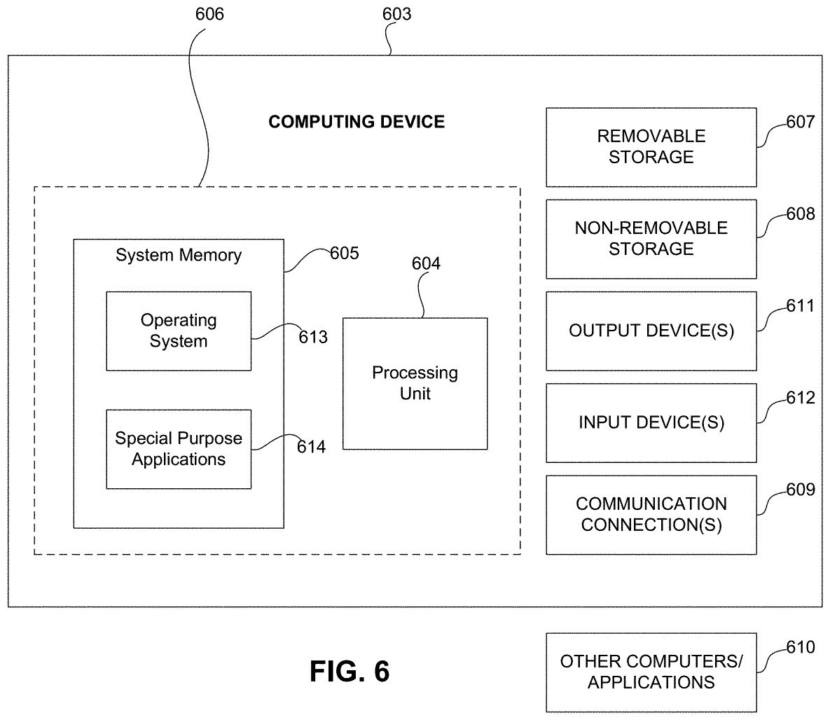

FIG. 6 is a functional block diagram of an exemplary special-purpose computing device 603 that may be used to implement one or more embodiments of the system and methods described herein. The computing device 603, in one basic configuration, includes a processor 604 and a memory 605. Depending on the exact configuration and type of computing device, memory 605 may be volatile (such as RAM), non-volatile (such as ROM, flash memory, etc.), or some combination of the two.

Memory 605 includes at least an operating system 613 and may additionally include other special purpose applications 614. The operating system 613 includes components and functions to enable the computing device 603 to function at a basic level. Examples of the operating system components may include a file system and graphical user environment. The operating system 613 may also include components (such as software instructions, modules, etc.) for communicating over a local or wide area network, such as an Internet browser. Special purpose applications 614 may include software instructions or modules to enable the computing device 603 to perform specific tasks. For instance, the special purpose applications 614 may include an authentication facility, an authenticator, or the like. In addition, like the operating system 613, the special purpose applications 614 may also include software instructions or modules for communicating over a local or wide area network, such as an Internet browser, or the like.

Computing device 603 may also have other features and functionality. For example, device 603 may include additional storage (removable and/or non-removable) including, but not limited to, magnetic or optical disks or tape. Such additional storage is illustrated in FIG. 6 by removable storage 607 and non-removable storage 608. Computer storage media includes volatile and nonvolatile, removable and non-removable media implemented in any method or technology for storage of information such as computer readable instructions, data structures, program modules or other data. Memory 605, removable storage 607 and non-removable storage 608 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transient medium which can be used to store the desired information and which can accessed by device 603. Any such computer storage media may be part of device 603.

Computing device 603 includes one or more communication connections 609 that allow computing device 603 to communicate with one or more computers and/or applications 610. Device 603 may also have input device(s) 612 such as a keyboard, mouse, digitizer or other touch-input device, voice input device, etc. Output device(s) 611 such as a monitor, speakers, printer, PDA, mobile phone, and other types of digital display devices may also be included. These devices are well known in the art and need not be described in further detail herein.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar references in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described, are possible. Similarly, some features and sub-combinations are useful and may be employed without reference to other features and sub-combinations. Embodiments have been described for illustrative and non-restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

What is claimed is:

1. A system for providing a child pick-up service to a user, the child being picked-up by a service provider at a location and provided to the user, the system comprising:
a first electronic data processor programmed with a first set of computer-executable instructions;
a first electronic data storage element in which is stored the first set of computer-executable instructions, wherein when the first electronic data processor executes the first set of computer-executable instructions, the system operates to
receive a request for the child pick-up service generated by a user device and communicated over a network to the first electronic data processor, and in response determine a set of one or more potential service providers of the requested child pick-up service;
filter the set of one or more potential service providers of the requested child pick-up service to identify a preferred service provider;
generate a message to the preferred service provider, the message including at least an identification of a child to be picked-up, an identification of a location at which the child is to be picked-up, and an identification of where the child is to be provided to the user;
receive from the preferred service provider a message accepting the request to pick-up the child;
generate a message to an entity at the location at which the child is to be picked-up, the message including at least an identification of the child to be picked-up and an identification of the preferred service provider;
receive a response from the entity at the location at which the child is to be picked-up, the response including at least a confirmation that the child was picked-up by the preferred service provider;
receive a signal or signals from a device associated with the preferred service provider, the received signals being used to determine an approximate location of the preferred service provider in transit from the location at which the child was picked-up to where the child is to be provided to the user;
receive a message from the user conforming that the child has been provided to the user by the preferred service provider; and
transfer a previously agreed upon amount of value from an account associated with the user to an account associated with the preferred service provider.

2. The system of claim 1, further comprising:
a second set of computer-executable instructions, the second set of computer-executable instructions stored in a second electronic memory element in the user's device, wherein when a second electronic data processor in the user's device executes the second set of instructions, the system operates to:
generate a display on the user device, the display including a selectable option to generate a request for a pick-up service for a child from the location;
receive a selection of the selectable option and in response, generate the request for the child pick-up service;
cause the user's device to transmit the request for the child pick-up service to the first electronic data processor;
receive from the first electronic data processor an identification of the preferred service provider;
generate a display on the user device, the display including a selectable option to generate a response approving the preferred service provider;
receive a message at the user device generated by the entity at the location, the message including at least a confirmation that the child was picked-up by the preferred service provider at the location;
receive data used by the user device to generate a display indicating an approximate location of the preferred service provider in transit from the location at which the child was picked-up to where the child is to be provided to the user;
in response to a user selection, generate a message confirming that the child has been picked-up by the user from the preferred service provider; and
in response to a user selection, request a transfer of the previously agreed upon amount of value from an account associated with the user to an account associated with the preferred service provider.

3. The system of claim 2, wherein the user device is one of a mobile phone, a tablet computer or a laptop computer.

4. The system of claim 2, wherein the location is a childcare facility and the entity at the location is an operator or employee of the childcare facility.

5. The system of claim 1, wherein determining the set of one or more potential service providers of the requested child pick-up service further comprises determining the set based on consideration of one or more of the location of the potential service provider, the availability of space in a vehicle of the potential provider, the location where the child is to be provided to the user, the time of day and the day of the week.

6. The system of claim 1, wherein filtering the set of one or more potential service providers of the requested child pick-up service to identify a preferred service provider further comprises filtering the set to select potential service providers who have previously been approved by the user.

7. The system of claim 6, wherein the location is a childcare facility and the potential service providers who have previously been approved by the user are those who the user has met at an event organized by the childcare facility and communicated with through the system's communication function.

8. The system of claim 2, wherein the system operates to calculate an estimated time for the user to travel to the location and notifies the user of when they should leave their current location to travel to the location, wherein the estimated time is based on at least the current location of the user and the location where the child is to be picked-up.

9. The system of claim 2, wherein the amount of value is based on the amount of time the provider of the service spent performing the service.

10. One or more computer-readable mediums comprising instructions which, when executed by one or more computing devices, collectively cause the computing devices to
generate a display on a user device, the display including a selectable option to generate a request for a pick-up service for a child from a location;
receive a selection of the selectable option and in response, generate a request for a child pick-up service;
cause the user's device to transmit the request to a remote electronic data processor;
receive the request generated by the user device after communication over a network to the remote electronic data processor, and in response determine a set of one or more potential service providers of the requested child pick-up service;
filter the set of one or more potential service providers of the requested child pick-up service to identify a preferred service provider;
receive at the user device an identification of the preferred service provider;
generate a display on the user device, the display including a selectable option to generate a response approving the preferred service provider;
receive at the remote electronic data processor the response approving the preferred service provider;
generate a message to the preferred service provider, the message including at least an identification of a child to be picked-up, an identification of a location at which the child is to be picked-up, and an identification of where the child is to be provided to the user;
receive from the preferred service provider a message accepting the request to pick-up the child;
generate a message to an entity at the location at which the child is to be picked-up, the message including at least an identification of the child to be picked-up and an identification of the preferred service provider;
receive a response at the remote electronic data processor from the entity at the location at which the child is to be picked-up, the response including at least a confirmation that the child was picked-up by the preferred service provider;
receive data used by the user device to generate a display indicating an approximate location of the preferred service provider in transit from the location at which the child was picked-up to where the child is to be provided to the user;
in response to a user selection, generate a message confirming that the child has been picked-up by the user from the preferred service provider; and
in response to a user selection, request a transfer of the previously agreed upon amount of value from an account associated with the user to an account associated with the preferred service provider.

11. The one or more computer-readable mediums of claim 10, wherein the user device is one of a mobile phone, a tablet computer or a laptop computer.

12. The one or more computer-readable mediums of claim 10, wherein the location is a childcare facility and the entity at the location is an operator or employee of the childcare facility.

13. The one or more computer-readable mediums of claim 10, wherein determining the set of one or more potential service providers of the requested child pick-up service further comprises determining the set based on consideration of one or more of the location of the potential service provider, the availability of space in a vehicle of the potential provider, the location where the child is to be provided to the user, the time of day and the day the week.

14. The one or more computer-readable mediums of claim 10, wherein filtering the set of one or more potential service providers of the requested child pick-up service to identify a preferred service provider further comprises filtering the set to select potential service providers who have previously been approved by the user.

15. The one or more computer-readable mediums of claim 14, wherein the location is a childcare facility and the potential service providers who have previously been approved by the user are those who the user has met at an event organized by the childcare facility.

16. The one or more computer-readable mediums of claim 12, further comprising instructions which, when executed by the one or more computing devices, collectively cause the computing devices to calculate an estimated time for the user to travel to the location and notifies the user of when they should leave their current location to travel to the location, wherein the estimated time is based on at least the current location of the user and the location where the child is to be picked-up.

17. The one or more computer-readable mediums of claim 10, wherein the amount of value is based on the amount of time the provider of the service spent performing the service.
